(19) United States
(12) Patent Application Publication
(10) Pub. No.: US 2006/0059005 A1
(43) Pub. Date: Mar. 16, 2006

(54) Systems and methods for managing data in an advanced planning environment

(75) Inventors: Matthias Horn, Sandhausen (DE); Stefan Forster, Hockenheim (DE); Gerhard Fuchs, Sinsheim (DE); Thomas Rumbach, Heidelberg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SAP Aktiengesellschaft

(21) Appl. No.: 10/939,524

(22) Filed: Sep. 14, 2004

(51) Int. Cl. G06Q 99/00; G05B 19/418

(52) U.S. Cl. 705/1; 705/8; 705/9

(57) ABSTRACT

Systems and methods are disclosed for managing data in an advanced planning environment. In one exemplary method, data is managed during the execution of a plurality of planning services, the planning services using one or more objects represented by data stored in a database. The method may include reading a planning profile with at least one process block, the at least one process block including a list of planning services to be executed and a selection profile, the selection profile including selection criteria for specifying which of the objects stored in the database are required for processing the at least one process block. The method may further include providing a data manager for each object to be processed in connection with the at least one process block, and executing each planning service in accordance with the list of planning services and the objects specified by the selection criteria, whereby each data manager controls the access of data to and from the database during the execution of the planning services.

### BACKGROUND OF THE INVENTION

I. Field of the Invention

The present invention generally relates to electronic data processing and to computerized systems and methods for managing data. More particularly, the present invention relates to systems and methods for managing data in an advanced planning environment, including systems and methods that manage data by buffering and controlling access to a database.

II. Background Information

Through advances in software, many types of processes have become automated. For example, computerized systems enable organizations to perform tasks related to different areas of their business, such as enterprise resource planning (EPR), supply chain management (SCM), customer relationship management (CRM), warehouse management (WM), and product lifecycle management (PLM). Such solutions have become so ubiquitous that companies from large to small rely upon them to efficiently run their operations and maximize profit.

Hardware and processing innovations have also led to higher levels of automation in the business world. For example, database solutions permit companies to store and utilize large quantities of data of various types (e.g., master data, transactional data, etc.). Such data may be used for various purposes, including planning and analysis. Furthermore, innovations in processing methods and related technologies enable businesses to perform complex calculations in various environments, including advanced planning environments.

Despite these advances, automated planning systems and methods suffer from several drawbacks. For example, complex calculations can be very expensive in terms of processing time if they require a high number of steps to be completed. Furthermore, if large quantities of data are involved in performing a set of calculations, then satisfactory response times may not be attainable. For instance, with current solutions, response times may range from tens of minutes to many hours or, even, one or more days. For calculations that need to be performed on a daily basis or repeated frequently, such response times can be very troublesome and, in some circumstances, unacceptable.

Current planning systems and methods also do not provide sufficient flexibility to end users. For instance, in advanced planning environments, companies often do not have the ability to select and control the manner and way in which calculations or processes are executed. Further, sufficient tools are not available to customize or adjust the manner in which processing is performed so that it best fits the needs of the user or the nature of the calculations and data involved.

### SUMMARY OF THE INVENTION

Consistent with embodiments of the present invention, systems and methods are disclosed for managing data. Systems and methods consistent with the invention may be implemented in advanced planning environments for managing data during, for example, the execution of a plurality of services. The services may be planning services that are executed in connection with one or more objects, wherein the objects are represented by data in a database.

In accordance with one embodiment, a method is provided for managing data for the execution of a plurality of planning services, the planning services using one or more objects represented by data stored in a database. The method may include reading a planning profile with at least one process block, the at least one process block including a list of planning services to be executed and a selection profile, the selection profile including selection criteria for specifying which of the objects stored in the database are required for processing the at least one process block. The method may further include providing a data manager for each object to be processed in connection with the at least one process block, and executing each planning service in accordance with the list of planning services and the objects specified by the selection criteria, whereby each data manager controls the access of data to and from the database during the execution of the planning services.

According to another embodiment, a system is provided for managing data in connection with the execution of planning services. The system may include a database for storing one or more objects, each of the objects being represented by data in the database, and a plurality of planning services, each of the planning services being implemented with software and providing predetermined functionality. Further, the system may include an advanced planning manager for executing the plurality of services and managing the access of the objects to and from the database. The advanced planning manager may comprise programmable instructions for causing a processor to perform the following steps: reading a planning profile with at least one process block, the at least one process block including a list of planning services to be executed and a selection profile, the selection profile including selection criteria for specifying which of the objects stored in the database are required for processing the at least one process block; providing a data manager for each object to be processed in connection with the at least one process block; and executing each planning service in accordance with the list of planning services and the objects specified by the selection criteria, whereby each data manager controls the access of data to and from the database during the execution of the planning services.

According to still another embodiment, a system is provided for managing data. The system may include means for reading a planning profile with at least one process block, the at least one process block including a list of planning services to be executed and a selection profile, the selection profile including selection criteria for specifying which of the objects stored in the database are required for processing the at least one process block. Further, the system may include means for providing a data manager for each object to be processed in connection with the at least one process block, and means for executing each planning service in accordance with the list of planning services and the objects specified by the selection criteria, whereby each data manager controls the access of data to and from the database during the execution of the planning services.

In accordance with yet another embodiment, a computer program product is provided comprising a computer readable medium with instructions for causing a processor to perform a method for managing data. As disclosed herein, the method may include reading a planning profile with at least one process block, the at least one process block including a list of services to be executed and a selection profile, the selection profile including selection criteria for specifying which of objects stored in a database are required for processing the at least one process block. Further, the method may comprise providing a data manager for each object to be processed in connection with the at least one process block, and executing each service in accordance with the list of services and the objects specified by the selection criteria, whereby each data manager controls the access of data to and from the database during the execution of the services.

It is to be understood that both the foregoing general description and the following detailed description are exemplary and explanatory only, and should not be considered restrictive of the scope of the invention, as described and claimed. Further features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects consistent with the present invention. In the drawings:

FIG. 1 is a block diagram of an exemplary planning environment, consistent with an embodiment of the present invention;

FIG. 2 is a block diagram of another exemplary planning environment, consistent with an embodiment of the present invention;

FIG. 3 illustrates an exemplary planning profile that includes process blocks, consistent with an embodiment of the present invention;

FIG. 4 is a flow chart of an exemplary method for processing a planning profile and executing services, consistent with an embodiment of the present invention;

FIG. 5A is a diagram of exemplary process of processing packages sequentially, consistent with an embodiment of the invention;

FIG. 5B is a diagram of an exemplary process of processing packages in parallel, consistent with an embodiment of the invention;

FIG. 6 illustrates an exemplary planning profile with a plurality of process blocks, consistent with an embodiment of the invention;

FIG. 7 illustrates another exemplary planning profile with a process block, consistent with an embodiment of the invention;

FIG. 8 illustrates exemplary trigger groups, consistent with an embodiment of the invention;

FIG. 9 illustrates an exemplary database table for trigger group management, consistent with an embodiment of the invention;

FIGS. 10A-10H illustrate exemplary interfaces for enabling a user to define and manage trigger groups, consistent with embodiments of the invention; and

FIG. 11 is an exemplary class diagram for implementing a data manager, consistent with an embodiment of the invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with embodiments of the present invention provide a framework for managing data and executing services. As used herein, the term “service” comprises any functionality or process that can be implemented in whole or in part through software or computerized-based technology. Examples of services include planning services. Planning services may include, for example, planning functionality such as forecasting, inventory planning, distribution requirements planning, deployment, route determination, scheduling, etc. The same planning services may be used for simulation as well. Services may also comprise reusable services, such as rounding, averaging, and the like. Consistent with embodiments of the invention, planning services and other types of services may be embodied in software-based applications or modules. By way of non-limiting examples, planning services may be embodied in planning modules or applications for enterprise resource planning (EPR), supply chain management (SCM), customer relationship management (CRM), warehouse management (WM), and product lifecycle management (PLM).

A service may comprise a plurality of calculations and involve one or more objects. As used herein, a “calculation” comprises a computation or execution required by an application or module for performing a service. Any given calculation may involve one or more steps. Further, the term “object,” as used herein, comprises an entity or item for which the calculation is performed. Examples of objects include modeled real-world objects, such as parts or products. Other examples of objects include location, location product, transportation lane, bill of distribution (BoD), etc. In one embodiment of the invention, objects are represented by data and may correspond to the input or output of one or more calculations.

Consistent with embodiments of the invention, the number of calculations and objects can vary depending on the needs of the end user or complexity of the service. In the context of planning services, the complexity of a service can be high and involve many planning calculations and planning objects. Furthermore, within any given environment, certain planning services may be of less complexity and involve fewer calculation or objects.

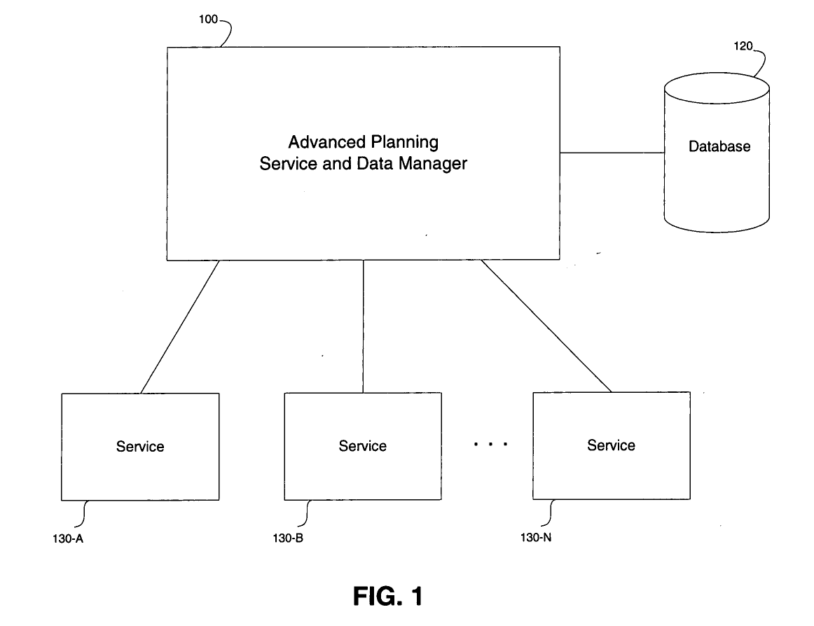

Referring now to FIG. 1, an exemplary environment for implementing embodiments of the invention will be described. In FIG. 1, an advanced planning environment is shown that comprises a plurality of services 130-A to 130-N and a database 120. Advanced planning service and data manager 100 is also provided for managing data and the execution of services, consistent with the teachings of the invention.

Advanced planning manager 100 and the components of FIG. 1 may be implemented through any suitable combination of hardware, software and/or firmware. Further, the features of FIG. 1 and related to embodiments of the invention may be implemented into or with commercially available system environments and/or components. By way of example, the advanced planning manager of FIG. 1 may be implemented in a SCM and SAP® R/3 Enterprise using an SAP® NetWeaver system environment, available from SAP AG (Walldorf, Germany).

Advanced planning service and data manager 100 may provide a framework for executing services 130-A to 130-N and managing the access and storage of data to and from database 120. In one embodiment, services 130-A to 130-N may be planning services that are embodied as software-based applications or modules. As disclosed above, planning services may provide functionality for various types of organizational planning, such as enterprise resource planning, supply chain management, warehouse management, customer relationship management, and product lifecycle management. These and other types of services may be provided alone or in any combination. Furthermore, while FIG. 1 illustrates three service modules, any number of services may be provided.

Consistent with embodiments of the invention, advanced planning service and data manager 100 may control and run pre-set sequence(s) of services according to criteria defined by a user. As further disclosed herein, a user may define settings for processing services through a planning profile. In general, a planning profile may define the sequence of services to be executed, the selection of object(s) to be processed, and/or additional parameters that indicate how to process the services. Advanced planning manager 100 may also perform or provide methods to create packages in order to reduce the number of the selected objects to be executed simultaneously.

Advanced planning service and data manager 100, consistent with embodiments of the invention, may also provide data management during the execution of services. Data management may include the control of access and storage of data to and from database 120. For companies, organizations and other users, database 120 may be adapted to store large quantities of data of various types (e.g., master data, transactional data, etc.). Advanced planning service and data manager 100 may buffer and/or control the buffering of data from database 120 during the execution of services 130-A to 130-N. For this purpose, each data object stored in database 120 may have its own data manager. As further disclosed herein, the services may read and write data through an interface for each data manager. Further, each data manager may provide buffering and save modified data to database 120. Such data management can reduce the frequency or number of database accesses and, thus, improve processing time.

Advanced planning service and data manager 100 may be implemented using a workstation, server, mainframe computer, personal computer, network computer, or other computing-based platform. Further, the above-described functionality and features of advanced planning manager 100 may be embodied in software or computer-readable instructions. Such software or computer-readable instructions may be sold or provided as one or more computer software products. Advanced planning service and data manager 100 may also be practiced in distributed computing environments, where tasks are performed by one or more computing or processing devices. As will be appreciated by those skilled in the art, the aforementioned systems and devices are merely examples and advanced planning manager 100 may comprise other systems or devices.

In one embodiment, advanced planning manager 100 may be configured as an object-orientated programming (OOP) implementation running on a computing based platform. Interfaces may be provided for communication between the advanced planning manager 100 and services 130-A to 130-N. Furthermore, services 130-A to 130-N may be embodied as software-based modules or applications. The service modules may reside on the same or a different computing-based platform supporting the advanced planning manager 100. In the later case, a network environment may be provided to support communication between the various platforms and, thus, between the advanced planning manager 100 and services 130-A to 130-N. For this purpose, various types of networks may be used, including a local area network (LAN) or a wide area network (WAN). Such networking environments are commonplace in offices, enterprise-wide computer networks, intranets, and the Internet, and are known by those skilled in the art.

By way of non-limiting examples, database 120 may be implemented as a database or collection of databases to store data. To collect data for storage, database 120 may be provided with a data collection module or interface to gather or receive data from various sources. In one embodiment, data source(s) of an enterprise may post or store enterprise-wide data (e.g., transactional data) to database 120. To store data, database 120 may be implemented as a mass or high-density storage system. As can be appreciated by those skilled in the art, various database arrangements may be utilized to store data in database 120, including relational or hierarchical database arrangements. In one embodiment, database 120 may be configured to store large quantities of data as part of a data warehouse for a company or enterprise. Database 120 may be implemented through conventional storage devices or commercially available databases. Examples of commercially available databases include SAP® MaxDB, IBM® Universal DB2 and iSeries, Informixe Dynamic Server, Microsoft® SQL Server and Oracle® 9iDatabase.

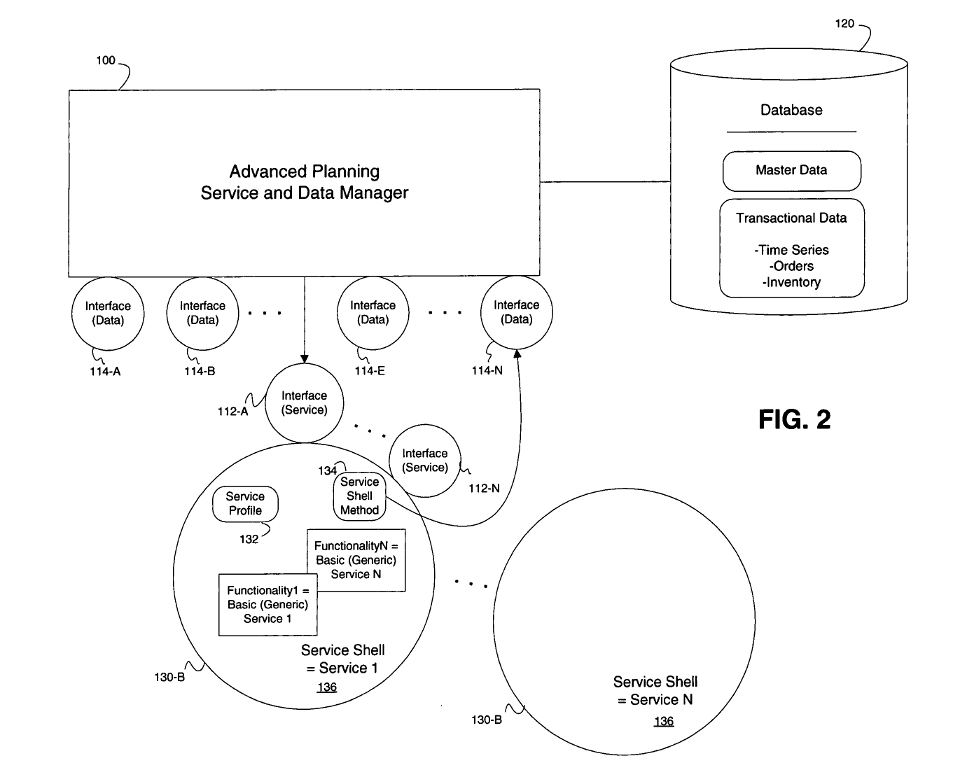

To provide a further understanding of the teachings of the present invention, FIG. 2 illustrates an exemplary system environment for implementing advanced planning service and data manager 100 and its related components. The embodiment of FIG. 2 will be described with reference to services that are implemented as planning services. In FIG. 2, one such service 130-B is illustrated in greater detail. As will be appreciated from this disclosure, other types of services may be implemented and the number and type of services is not limited to that illustrated and described with reference to FIG. 2.

Service 130-B may be embodied as a software-based module with specific functionality or one or more basic (generic) services or methods (e.g., Service 1 to Service N, as shown in FIG. 2). A service shell 136 may be provided for each service of service 130-B to facilitate communication between the service and advanced planning manager 100. The service shell may be an object-orientated class that implements at least one service interface method. In the following description, features related to the service shell 136 for Service 1 are described in detail. As will be appreciated by those skilled in the art, such features are applicable to the service shells for other implemented services (e.g., Service 2 through Service N).

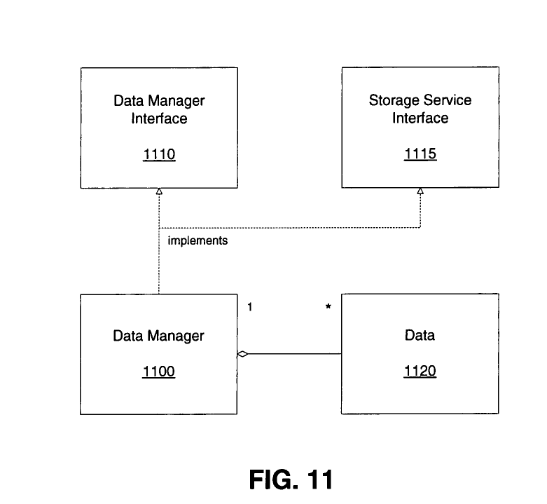

In the embodiment of FIG. 2, service shell 136 for Service 1 is illustrated as implementing the service interface method for one or more interfaces 112-A to 112-N. Consistent with embodiments of the invention, advanced planning manager 100 may include a plurality of interfaces, which may implemented as OOP classes. These interfaces may include a plurality of interfaces 112-A to 112-N for communicating with the services and a plurality of interfaces 114A-114N for handling data for each planning object. As disclosed herein, a data manager may also be provided for each planning object or data type. An exemplary class diagram for implementing a data manager is described below with reference to FIG. 11.

Consistent with the invention, each service module may be provided with a service shell, and each service shell may implement at least one service interface method. The service interfaces (112A-112N in FIG. 2) may be OOP interfaces and permit advanced planning manager 100 to call service(s) according to each planning profile. In accordance with one embodiment of the invention, a service may have planning functionality, from simple to complex, to execute planning methods, algorithms and/or processes.

As further shown in FIG. 2, each service may also include a service profile and a service shell method. For example, service 130-B includes a service profile 132 and a service shell method 134. The service profile may contain settings for the service(s), which are independent of the data. Service profiles may be used for defining the planning profiles, as discussed further below. Service shell method 134 may encapsulate one or more service shell methods for encapsulating, for example, data and other items. By way of non-limiting examples, service shell methods may be provided for data access methodologies and/or for obtaining service profile data from database 120. In one embodiment, service shell method 134 is made optional.

Database 120 may store various types of data, including enterprise-wide data such as master data and transactional data. As disclosed herein, the data stored in database 120 may represent objects and may be used when processing services. Master data may include, for example, data pertaining to product, location, location product, transportation lane, etc. Transactional data may include, for example, data pertaining to inventory, orders (including stock or product transfer orders), sales, etc. Transactional data may also comprise time series data. The above-noted items are merely examples and, as will be appreciated by those skilled in the art, other types data may be stored in database 120 according to the needs of the user and/or the advanced planning environment.

To control access by the services to data stored in database 120, advanced planning manager 100 may comprise a data manager for each object or data type (not shown in FIG. 2). Interfaces 114A-114N facilitate communication between the various services and data managers. During execution, each data manager may control the access to data by the various services and buffer data (as needed) from database 120. The buffering of data may be required if one or more of the following conditions exist: the data is used by more than one service; the data is needed more than one time in execution of the service; the data is changed or new data is created; and/or accessing the data is expensive (e.g., with respect to processing time or capacity). Additional features and embodiments related to the data managers and data management are provided below (see, e.g., FIG. 11).

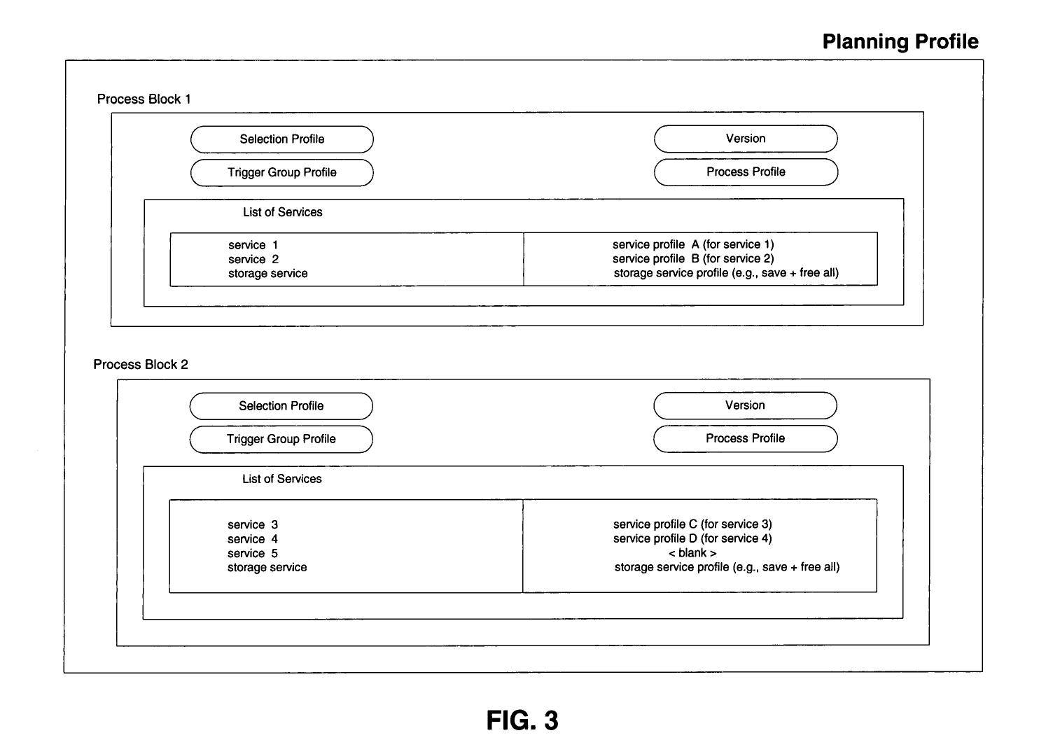

FIG. 3 illustrates an exemplary planning, profile, consistent with an embodiment of the invention. Planning profiles, such as that illustrated in FIG. 3, may be defined by a user to create job chains and to execute one or more services. Planning profiles can be set-up once and stored in database 120 or other memory or storage device(s). Planning profiles may be used by advanced planning manager 100 for executing pre-set sequences of planning services. When needed, planning profiles may be modified or updated by the user to improve performance or adjust planning calculations or steps.

As shown in FIG. 3, a planning profile may comprise one or more process blocks. When creating a planning profile, a user may decide what process blocks to include and how many process blocks to arrange within each planning profile. The user may also define the sequence of the process blocks and what services to include in the list of services for each process block. In the exemplary embodiment of FIG. 3, two process blocks are shown (Process Block 1 and Process Block 2). The first process block (Process Block 1) includes three services (service 1, service 2, and storage service) and the second process block (Process Block 2) includes four services (service 3, service 4, service 5, and storage service). Between process blocks, some of the services may be common (e.g., the storage service). Further, the execution of certain services may be automated. For example, in one embodiment, the storage service may be executed automatically as the last service following the list of services designated by the user, so that the storage service does not always need to be included in the list of services or otherwise designated by the user. As further disclosed herein, the storage service may save all changed and new data in the data manager buffer, and may clear the buffer afterwards. As will be appreciated by those skilled in the art, the embodiment of FIG. 3 is provided for purposes of illustration, and the number of process blocks and services defined for a process profile may be greater or less than that shown in FIG. 3.

Consistent with embodiments of the invention, each process block may define a list of services and corresponding service profiles. A list of services may include one or more services. For example, as indicated above, the first process block (Process Block 1) in FIG. 3 includes a list of services comprising thee services (service 1, service 2, and storage service). The list of services within each block may involve or require the same planning objects. For instance, the services of the first process block may involve one set or type of data objects, whereas the list of services for the second process block may involve another set or type of data objects. A service profile may be defined for a service within the list of services. The service profile may define service-dependent data for executing the service (e.g., time series, model, planning horizon, etc.). For instance, the storage service may have a storage service profile, and another service, such as a forecast service, may have a forecast service profile. If a service does not require a service profile, the service profile field may be left blank. This may be useful for executing a service (e.g., service 5 in Process Block 2) that does not require a service profile.

Services may be provided by advanced planning manager 100 to provide technical functionality. These services may be executed like any other service, but may be special services for providing certain functionality. By way of example, a storage service may be provided to save changed data in database 120 and reset the data buffers of the relevant data manager(s). The storage service profile for the storage service may define, for example, which data will be saved and reset. Flags may be provided to save and/or reset for all data manager(s). In addition, the data can be saved and/or reset individually for each data manager. According to the settings, the data: first, may be saved for all data managers; second, may be reset for all data managers; and, finally, the list of data manager may be processed-again first saved and then reset for each data manager. The storage service may be called (e.g., automatically or as part of the list of services defined by the user) at the end of a process block (such as in FIG. 3) or may be called elsewhere. Furthermore, there may be only one save of data to the database or memory per process block.

To create a planning profile, one or more user interfaces may be provided. Such an interface may include, for example, entry fields and control buttons for entering information. In one embodiment, a graphical user interface (GUI) is provided with message prompts, entry fields and/or control buttons to facilitate the creation of planning profiles by a user. Such a GUI may comprise one or more screens or windows to guide a user through the process of creating a planning profile. Help screens may provide information for the user, and/or drop-down menus or tables may provide lists of predefined services, profiles or other elements for selection by the user when creating a planning profile. Additionally, or alternatively, planning profiles may be created using a separate application or program and then stored for later access by the advanced planning manager 100.

Consistent with embodiments of the invention, each process block may include a set of parameters defined by a user that apply to the entire process block. Such parameters may be used for controlling, for example, the method of building packages for the planning objects, the size of such packages, and/or the method of processing such packages (e.g., parallel or serial processing). Such parameters and other settings may be saved as process profile data for each process block.

For example, in the embodiment of FIG. 3, each process block includes a selection profile. The selection profile includes a set of selection criteria to indicate which planning objects are to be selected from the database for the process block. Various criteria may be used to indicate what data should be selected, such as criteria to specify which master data and/or transactional data are required. By way of example, the criteria may specify the data by name of supplier, name of location, name of product, name of analyst or planner, etc. The data may also be specified depending on the type of planning algorithms or methods. For instance, if forecasting is to be performed, certain forecast models may require seasonal data, whereas other types of forecast models may require sporadic or constant data. In either case, the selection criteria may be defined by the user and stored as part of the selection profile.

Each process block may also include a process profile. With a process profile, the user may define a set of parameters or criteria for controlling how the advanced planning manager processes a process block. Such parameters may define the method of building packages for the planning objects, the size of such packages (e.g., minimum or maximum), and/or the method of processing such packages (e.g., serial or parallel processing). Various methods may be provided for building packages. By way of non-limiting examples, one or more of the following methods may be defined for building packages:
build into packages of the same package size n;
build into a given number n of packages;
build of type location product into packages with the same location;
build of type location product into packages with the same product;
build of type lane into packages with the same starting location; and
build of type lane into packages with the same destination location.
   In the above-listed examples, the package creation methods are described with reference to specific object types (e.g., location product, lane, etc.). As will be appreciated by those skilled in the art, these exemplary methods may be adapted for other types of objects and/or otherwise modified. Further, other package creation methods may be defined by a user, consistent with the teachings of the present invention.

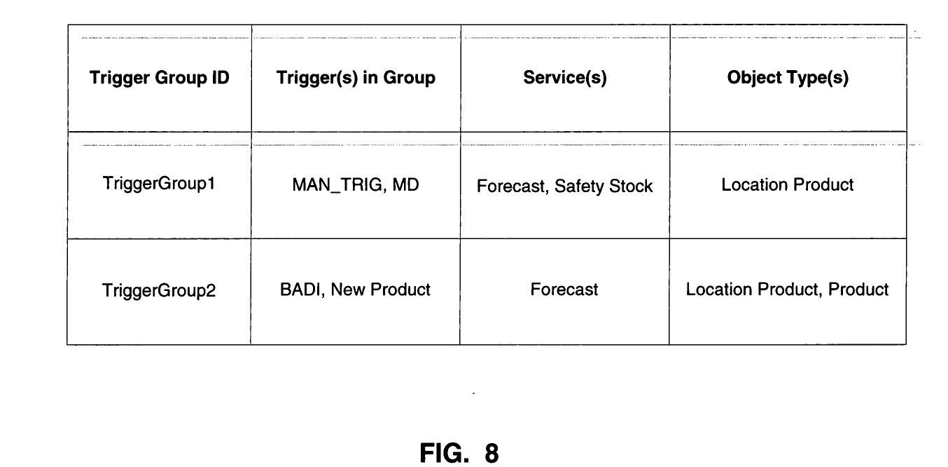

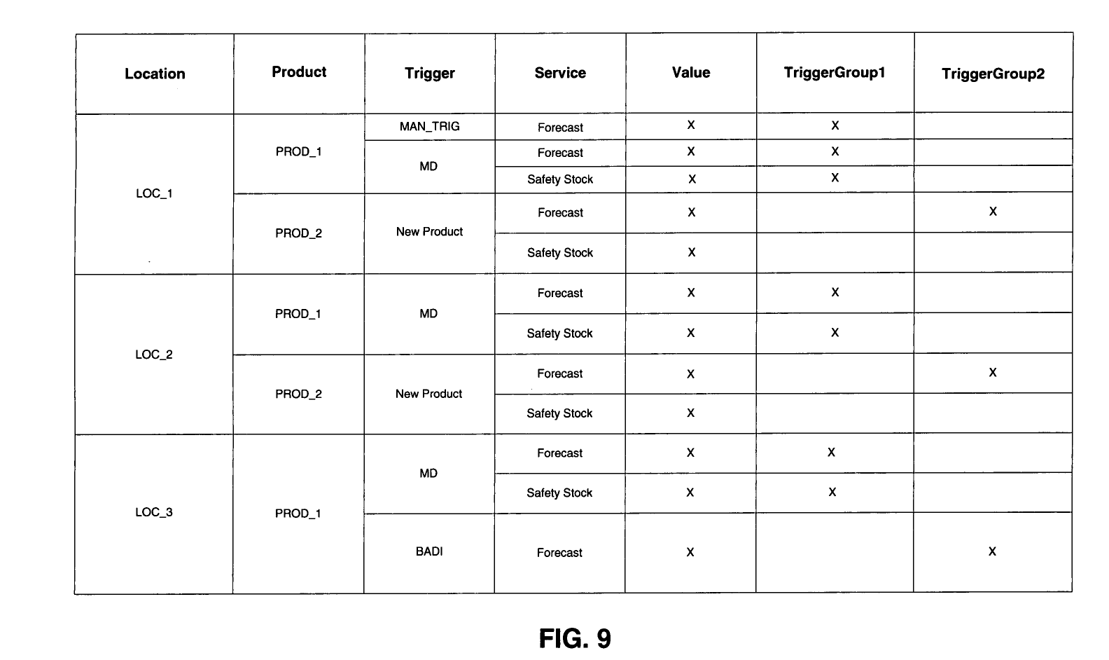

In accordance with embodiments of the invention, other parameters may be defined by a user for each process block. For example, as illustrated in FIG. 3, information to define version(s) may be provided for a process block. By way of example, a user may define version information, including the version of the planning objects or data, such as for the source (active, inactive, etc.) and/or the results (actual, simulation, etc.). In addition, a user-defined trigger group profile may be included with each process block. The trigger group profile may identify a trigger group with one or more triggers for filtering or limiting the number of planning objects to be executed by the advanced planning manager, and/or other trigger related-parameter(s). Such triggers may be useful to eliminate unnecessary or redundant processing. In one embodiment, the use of triggers is made optional. The use of triggers and trigger groups is further described below with reference to the exemplary embodiments of FIGS. 8 and 9.

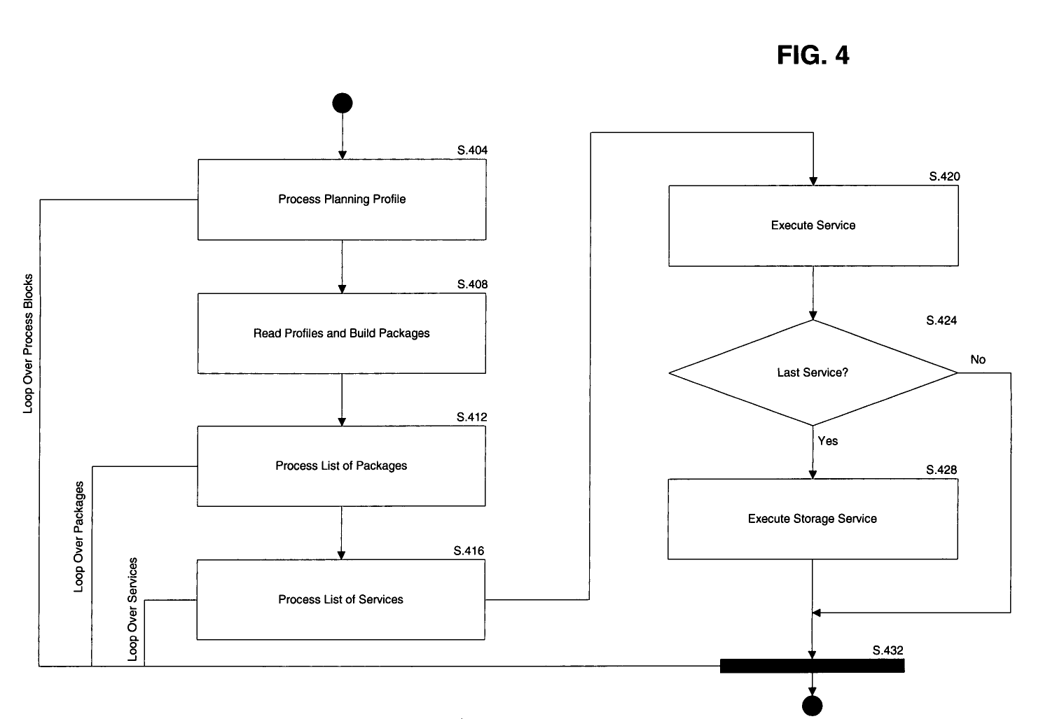

Referring now to FIG. 4, an exemplary method for processing a planning profile and executing services will be described. As disclosed herein, a planning profile may define the sequence of services, the selection of planning objects to be executed, and additional parameters on how to process the planning run. A planning profile may comprise one or more process blocks. Each process block may include a selection profile, a process profile and a list of services. The selection profile may define the planning objects to be executed by the services assigned to the list of services. Planning objects may be divided into packages according to the settings in the planning profile. Different methods to create or build packages may be selected or defined by a user for managing interdependencies between planning objects. Furthermore, the packages may be executed according to the settings in the process block.

As illustrated in FIG. 4, the method begins by processing a planning profile (step S.404). This may involve, for example, calling a planning profile with the advanced planning manager 100. In one embodiment, the planning profile may be called or read from database 120 or another suitable storage location. The reading of a planning profile may be scheduled (e.g., for batch or on-line processing) or otherwise controlled by the user. To process the planning profile, advanced planning manager 100 may read the profiles and parameters (e.g., the planning profile, process profile(s), selection(s), version(s), trigger group profile(s)) associated with the first process block (step S.408). As part of this step, the advanced planning manager may identify from the selection profile the relevant planning objects and services. In addition, advanced planning manager 100 may build packages according to the method selected or defined by the user.

As disclosed herein, with a process profile, the user may define the method of building packages (“package creation method”) for the planning objects. The process profile may also define the method of processing such packages. As will be appreciated by those skilled in the art, building packages may be useful when a large number of planning objects have been selected. The grouping of the selection into packages can improve system performance based on the type processing (e.g., parallel or sequential) and/or the size of the packages.

Various package creation methods may be defined. For purposes of illustration, assume that a user has selected one million planning objects. In the process profile, the user may define that packages be built using the same package size. For example, if a size n=1,000 is defined, then 1,000 packages would be built, each with the size of 1,000 planning objects. Alternatively, the user may define that a given number of packages be built. For instance, if the number of packages n=5,000 is defined, then 5,000 packages would be built, each with the size of 200 planning objects. It is also possible that the user may wish that all of the selected planning objects be grouped and processed as one package. In which case, the user may set the number of packages to be built equal to one (i.e., number of packages n=1) or no process for building packages may be defined.

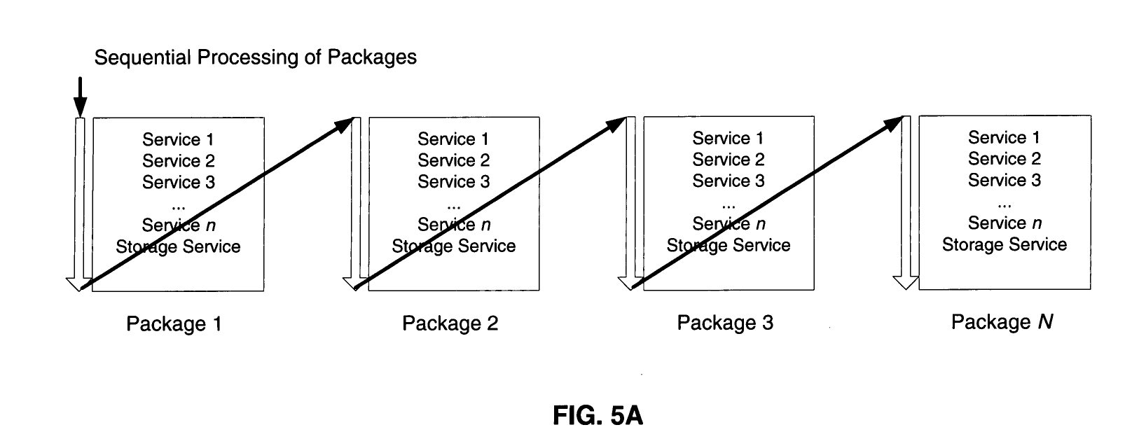

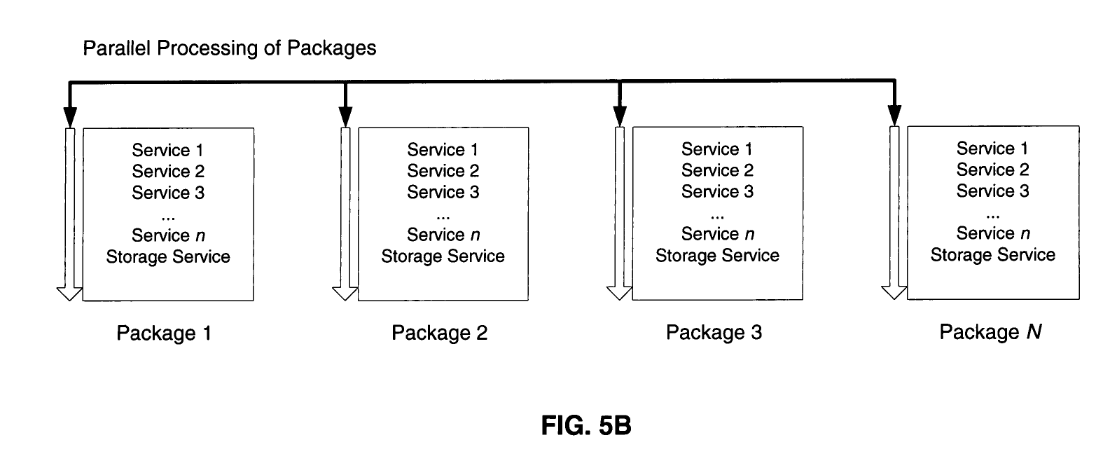

In addition to defining the method of building packages, a user may specify the manner in which the packages are to be processed. FIGS. 5A and 5B illustrated two exemplary methods of processing packages. In the exemplary embodiment of FIG. 5A, the packages (total number of packages=N) are processed sequentially. With sequential processing, the list of services from the process block may be executed based on the planning objects from each package, with the processing of each package handled sequentially (i.e., first Package 1, then Package 2, then Package 3, etc.). In contrast, the exemplary embodiment of FIG. 5B illustrates a situation where packages are processed in parallel. With parallel processing, the list of services from the process block may be executed using the planning objects from each package, with the processing of each package being handled in parallel (i.e., processing Package 1 in parallel with Package 2, Package 3, etc.). The maximum number of parallel processes may be defined by a user in the process profile (see, e.g., FIG. 3). One of ordinary skill in the art will recognize that the above-mentioned methods are exemplary and that the processing of packages may be handled in other ways, such as any combination of sequential and parallel processing.

As will be appreciated by those skilled in the art, whether or not a particular processing methodology provides improved or better performance will depend on a number of factors, including the size and number of packages, as well as the storage and processing capacity of the system environment.

Referring again to FIG. 4, packages may be built according to the defined methodology and based on the planning objects or data stored in database 120 (step S.408). The list of packages may then be processed according to a user-defined or default process (step S.412). In one embodiment, processing of the packages is performed sequentially, in parallel or as otherwise defined in the process profile.

While iteratively processing or looping over the packages, the list of services is processed (step S.416). As disclosed herein, the list of services for a process block may comprise one or more services. Advanced planning manager 100 may call and execute each service (step S.420). The list of services may be executed in the order that they are listed, with each service being executed with the packages of planning objects. As disclosed above, this may be done either sequentially (see FIG. 5A) or in parallel (see FIG. 5B).

As further shown in FIG. 4, advanced planning manager 100 may loop over the services until the last service has been executed (step S.424; Yes). A storage service or similar service may then be performed (step S.428) to store all new and changed data of the data manager in database 120 and reset the buffer(s) of the data manager(s) (as needed). Advanced planning manager 100 may then looping back (step S.432) in order to process the next process block of the planning profile. The packages and services for the next process block may then be executed (steps S.404-428) and the process may be repeated until the final process block in the planning profile has been reached.

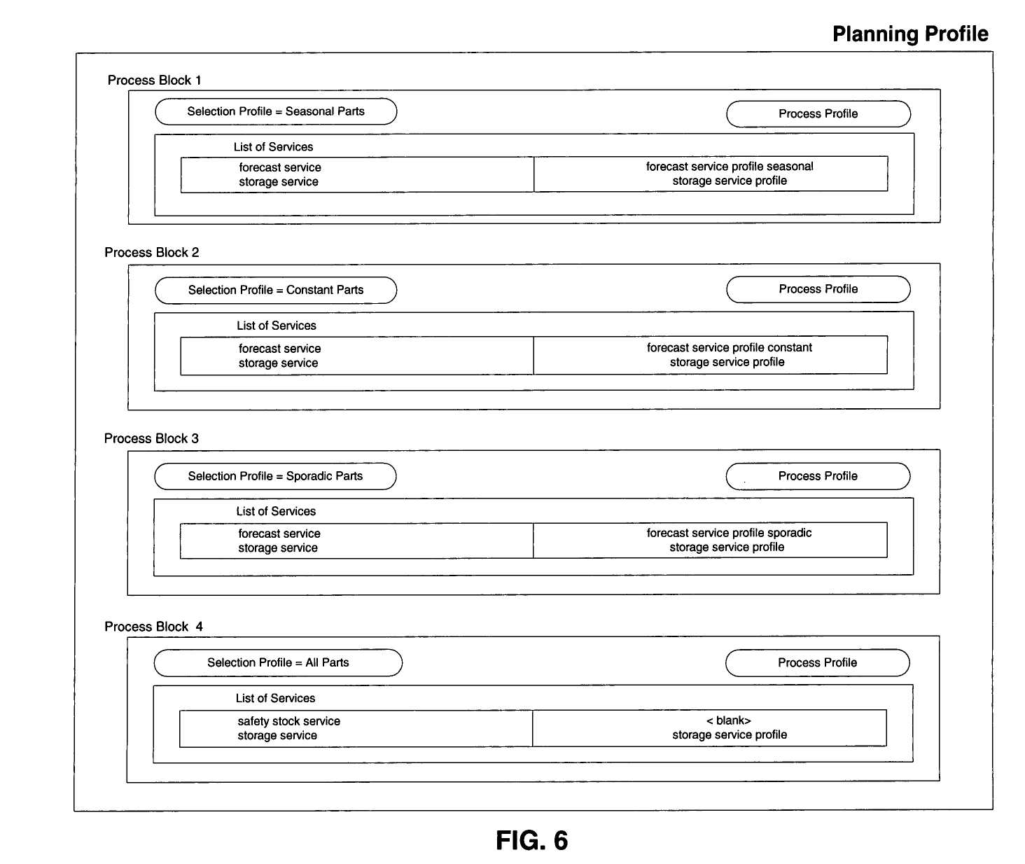

To further illustrate the scope of the present invention, the processing of process blocks for an exemplary planning profile will now be described in detail with reference to FIG. 6. The embodiment of FIG. 6 illustrates examples of planning calculations (e.g., forecasting, safety stock calculations, etc.) that a company or other entity may need to perform for various purposes, such as the handling and inventory management of parts.

As shown in the example of FIG. 6, the planning profile comprises a number of process blocks (Process Block 1, Process Block 2, Process Block 3, and Process Block 4). As disclosed herein, the selection and sequence of the process blocks may be defined by the user. In some cases, the order of the process blocks and/or the list of services in each process block may be important (e.g., to keep consistent with a predetermined process flow). In other cases, the order of process blocks and/or selection of services may not be as important.

In the exemplary embodiment of FIG. 6, four process blocks are defined. The first three process blocks (Process Block 1, Process Block 2 and Process Block 3) all include a forecast service. Such a forecast service may be adapted to calculate and forecast the demand for a particular product or type of parts. The order of these process blocks may not be important, given the nature of their services, which are independent from one another. However, in the embodiment of FIG. 6, the fourth process block (Process Block 4) preferably comes after the first three process blocks, because it involves a service (safety stock) that is dependent on the results of the forecast services of the first three process blocks. Thus, when defining the planning profile of FIG. 6, a user may order the fourth process block with the safety stock service after performing the process blocks with the requisite forecast services (i.e., Process Blocks 1-3).

Consistent with embodiments of the invention, control over what services are listed in each process block and the order of the process blocks, such as that described above, may be completely within the domain of the user. In one embodiment, a user interface (such as a GUI) and/or an application or program may be provided to assist a user in defining the services for each process block and the order of the process blocks in a planning profile.

The process blocks of FIG. 6 may include some services that are common. For example, in each of the process blocks a storage service is listed. Such a service may be a special service provided by advanced planning manager 100. In one embodiment, the storage service may be an automated service that is executed at the end of each process block. In such a case, a user may not need to define the service in the list of services for each process block. In another embodiment, the storage service may be an optional service and, thus, identified at any point in the list of services for a process block by the user. As disclosed herein, a storage service may save changed and new data in database 120 and reset the data buffers of the relevant data manager(s). The particular data to be saved and reset may be defined in the storage service profile associated with the storage service. As will be appreciated by those skilled in the art, other types of storage services may provided, alone or in combination with the storage service.

As will be appreciated by those skilled in the art, the embodiment of FIG. 6 is for purposes of illustration and the number of process blocks and services defined for a planning profile may be greater or less than that illustrated in FIG. 6.

Consistent with embodiments of the invention, each process block in the embodiment of FIG. 6 includes a list of services and corresponding service profiles. For example, as indicated above, the first process block (Process Block 1) in FIG. 6 includes two services (forecast service and storage service). The list of services within each block may involve or require the same planning objects. For instance, the services of Process Block 1 involve one set or type of planning objects (parts with a seasonal demand), whereas the list of services for the second process block (Process Block 2) involves another set or type of planning objects (parts with a constant demand). As disclosed herein, the type of planning objects selected for each process block may be defined by the user in the selection profile. Further, the specific source or type of data for executing a service in each process block may be defined through the corresponding service profile. For instance, in Process Block 1 of FIG. 6, a forecast service profile seasonal is defined for the forecast service. Forecast service profile seasonal may select the source of the data (e.g., time series data) for selected planning objects (seasonal parts). If a service does not require a service profile (such as the safety stock service of Process Block 4), the service profile field may be left blank.

Processing of the planning profile of FIG. 6 may involve, for example, calling the planning profile with advanced planning manager 100. Initially, advanced planning manager 100 may read the profiles and parameters associated with the first process block (Process Block 1). As part of this step, the advanced planning manager may identify from the selection profile the relevant planning objects and services. In the exemplary embodiment of FIG. 6, the selection profile for Process Block 1 identifies seasonal parts (e.g., parts which have a demand that tends to follow seasonal trend(s)). If applicable, advanced planning manager 100 may also build packages according to the method selected or defined by the user. For example, in the process profile for Process Block 1, the user may define a method of building packages for the planning objects. The process profile may also indicate the method of processing such packages (e.g., sequentially or in parallel).

Assuming that packages are built for Process Block 1, advanced planning manager may loop over the packages while executing the list of services (in this case, the forecast service and storage service). During this processing, the corresponding service profiles may be observed to select, for example, the correct source of data for the planning objects (e.g., the time series (type) is one attribute of the forecast service profile seasonal). By way of example, the forecast service for Process Block 1 may cause calculations to be performed for seasonal parts (identified by the selection profile) using time series data from the database. The forecast model used for the forecast service may be based on a model that is capable of computing forecasts based on seasonal trends.

After executing the forecast service for each package, the storage service may be performed to store changed and new data in database 120 and reset the appropriate buffer(s). When the last package is completed for Process Block 1, advanced planning manager 100 may loop back in order to process the next process block of the planning profile (in this case Process Block 2). The packages and services for Process Block 2 may then be executed and the entire process may be repeated until the final process block (Process Block 4) in the planning profile has been reached.

In Process Block 2, the selection profile identifies constant parts (i.e., parts which have a demand that tends to be constant). Advanced planning manager 100 may also read the other profiles and parameters associated Process Block 2, such as the process profile. As disclosed herein, the process profile may define the method or approach to be used for building packages and/or the method of processing such packages. Thus, a user may define that the packages be processed in-parallel (see, e.g., FIG. 5A) or sequentially (see, e.g., FIG. 5B).

As with Process Block 1, advanced planning manager may loop over the packages (if any) of Process Block 2 while executing the list of services (in this case, the forecast service with the forecast service profile constant and the storage service). During this processing, the corresponding service profiles may be observed to select, for example, the correct source of data for the planning objects (e.g., forecast service profile constant=time series data). By way of example, the forecast service for Process Block 1 may cause calculations to be performed for constant parts (identified by the selection profile) using time series data from the database. The forecast model used for the forecast service may be based on a model that is capable of computing forecasts for parts that have a fairly constant demand.

After executing the forecast service for each package, the storage service may be performed to store changed and new data in database 120 and reset the appropriate buffer(s). When the last package is completed for Process Block 2, advanced planning manager 100 may loop back in order to process the next process block of the planning profile (in this case Process Block 3).

Process Block 3 may be processed in a similar manner to that of Process Block 1 and Process Block 2. In Process Block 3, the selection profile identifies sporadic parts (i.e., parts which have a demand that tends to be sporadic). If packages are built according to the process profile, advanced planning manager 100 may loop over the packages of Process Block 3 while executing the list of services (in this case, the forecast service with the forecast service profile sporadic and the storage service). During this processing, the corresponding service profiles may be observed to select, for example, the correct source of data for the planning objects.

In contrast to Process Block 1 and Process Block 1, Process Block 3 includes a forecast service profile sporadic for the listed forecast service. The forecast service profile sporadic, in comparison to the forecast service profile seasonal, may identify a different source of data, such as a different type of time series data. Further, the forecast service for Process Block 3 may cause calculations to be performed for selected sporadic parts (identified by the selection profile) using the identified time series data from the database. The forecast model used for the forecast service may be based on a model that is capable of computing forecasts for parts that have a sporadic demand.

After executing the forecast service for each package, the storage service may be performed to store the final planning objects in database 120 and reset the appropriate buffer(s). When the last package is completed for Process Block 3, advanced planning manager 100 may loop back in order to process the next process block of the planning profile (in this case Process Block 4).

In Process Block 4, the selection profile identifies all parts (i.e., seasonal, constant and sporadic parts) and includes a safety stock service for calculating safety stock quantities. The safety stock quantities may be calculated for all parts based on, for example, the forecasts determined for the seasonal, constant and sporadic parts. For this reason, as explained above, Process Block 4 is defined by the user to follow Process Blocks 1-3 in the planning profile.

Since the safety stock service is computed with respect to all parts, a service profile may not be needed and the field can be left blank in the process block. With the process profile, a user may define the method or approach to be used for building packages and/or the method of processing such packages for the listed services of Process Block 4. Thus, a user may define that the packages be processed sequentially (see, e.g., FIG. 5A) or in parallel (see, e.g., FIG. 5B).

If packages are created, advanced planning manager may loop over the packages while executing the listed of services of Process Block 4 (in this case, safety stock and storage service). After processing all packages and storing changed and new data in database 120, the appropriate buffer(s) may be reset. At this point, the processing of the exemplary planning profile of FIG. 6 may be terminated.

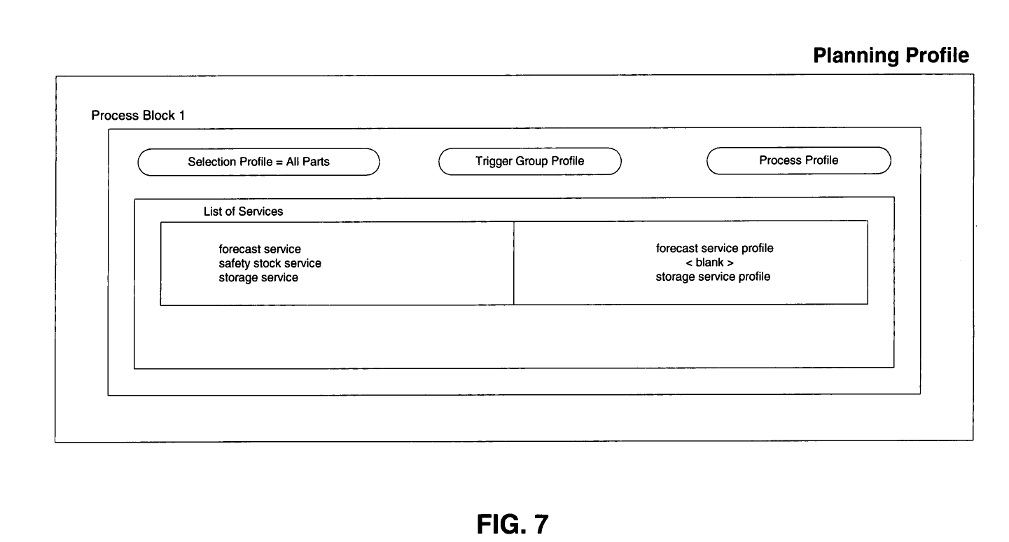

A planning profile, consistent with embodiments of the invention, may include any number of process blocks and listed services. For purposes of illustration, FIG. 7 shows another exemplary planning profile. In this embodiment, the planning profile is defined with a single process block. Similar to FIG. 6, the embodiment of FIG. 7 provides planning calculations (e.g., forecasting, safety stock calculations, etc.) that a company or organization may need to perform for various reasons, such as the handling and inventory management of parts. Other applications of the planning profile are, of course, feasible, consistent with the principles of the present invention.

As shown in FIG. 7, a single process block (Process Block 1) is defined that includes a number of listed services. The list of services includes a forecast service and a safety stock service for parts. The relevant planning objects or parts may be defined in the selection profile. In the case of FIG. 7, “all parts” (e.g., seasonal, constant and sporadic parts) are defined by the selection profile. Execution of the forecast and safety stock services may be performed for these parts to determine, for example, forecasting and safety stock quantities (as needed).

Processing of the planning profile of FIG. 7 may involve, for example, calling the planning profile with advanced planning manager 100. Initially, advanced planning manager 100 may read the profiles and parameters associated with Process Block 1. As part of this step, the advanced planning manager may identify from the selection profile the relevant planning objects (i.e., “all parts”). Advanced planning manager 100 may also build packages according to the method selected or defined in the process profile. By way of example, in the process profile for Process Block 1, the user may define a method of building packages (e.g., package size=1000; build packages by grouping according to part type or location) and the method of processing the packages (e.g., sequentially or in parallel).

With the packages built for Process Block 1, advanced planning manager may loop over the packages while executing the listed services (forecast service, safety stock service, and storage service). During this processing, the corresponding service profiles may be observed to select, for example, the correct source of data for the planning objects (e.g., forecast service profile=time series data). If no service profile is required, then the field may be left blank.

Consistent with an embodiment of the invention, service profiles may be defined or selected by a user through a computerized interface. Such an interface may include checkboxes or entry fields for selecting different characteristics related to a service profile in a process block. By way of example, for a forecast service profile, checkboxes may be provided in an interface to permit a user to select one or more different forecast models to be calculated, such as seasonal, constant and/or sporadic. In the example of FIG. 6, specific forecast models are shown as being selected (i.e., forecast service profile seasonal, forecast service profile constant, and forecast service profile sporadic). In contrast, in the example of FIG. 7, all forecast models are shown as being selected (i.e., forecast service profile).

In the exemplary embodiment of FIG. 7, the forecast service for Process Block 1 may cause calculations to be performed for all parts (e.g., seasonal, constant and sporadic) using time series and/or other data from the database. In addition, one or more forecast models may be used by the forecast service and applied according to, for example, the type of data being processed. The results of the forecast service may then be used by the safety stock service to calculated and determine relevant safety stock levels. Safety stock levels represent an amount of stock held in inventory to avoid shortages. After executing the forecast and safety stock services for each package, the storage service may be performed to store changed and new data in the database and reset the appropriate buffer(s).

As will appreciated by those skilled in the art, by including the forecast and safety stock calculations in a single process block and creating packages by grouping according to part type, improved performance can be achieved. This improvement can be measured in terms of the reduced access time to the database and/or improved processing time. As compared to the embodiment of FIG. 6, the exemplary embodiment of FIG. 7 can provide several advantages, including the reduction or elimination of database store/read operations between the executions of the services for the planning objects.

Consistent with another aspect of the present invention, a trigger profile may be defined for each process block and stored as part of a planning profile. For example, in the embodiment of FIG. 7, a trigger group profile is shown. Generally, a trigger profile may define the trigger(s) to be used by the advanced planning manager 100 when executing services. In such a profile, triggers may be defined individually (i.e., a trigger profile) or according to groups (i.e., a trigger group profile). Triggers may define, filter or limit the number of planning objects (i.e., data) to be executed by the advanced planning manager. As disclosed herein, such triggers may be useful to eliminate unnecessary or redundant processing of objects.

In relation to processing a planning profile, a trigger profile may be read by advanced planning manager 100 when checking other profile and parameter information for each process block, such as the selection profile. For example, with reference to the embodiment of FIG. 4, advanced planning manager 100 may read a trigger group profile and determine the status of the triggers when carrying out step S.408 for a process block. By checking the status of the trigger(s) identified in the trigger profile, the amount of objects or data for the selection may be determined.

Referring now to FIGS. 8 and 9, exemplary embodiments related to the use of triggers will be described. Consistent with the invention, triggers may be set or not set (i.e., active or non-active). The setting of triggers may be automatic or manually controlled by a user. Further, as will be appreciated from the following description, each trigger may be predefined for one or more planning services.

As disclosed herein, a process block may include a selection profile, a process profile and a list of services. The selection profile defines the planning objects to be executed by the services assigned to the list of services. Consistent with an aspect of the invention, the selected planning objects (i.e., data) can be filtered using the trigger functionality. A trigger may be implemented as a flag with a value to indicate whether the trigger is set (active) or not set (non-active). By way of example, a trigger with a value=‘1’ or ‘X’ may indicate that the trigger is set, whereas a trigger with a value=0 or ‘space’ may indicate that the trigger is not set. Triggers may be stored in database 120 or in other memory accessible by advanced planning manager 100. In one embodiment, triggers are stored and encapsulated from the advanced planning manager 100 so that they can be used by other applications.

To provide trigger functionality, trigger profiles may be defined for a process block. In accordance with one embodiment, a trigger group profile may be implemented and defined for each process block. The trigger group profile may define a trigger group consisting of one or more triggers. A trigger may be assigned to one or more services, and assigned to one or more object types (such as location product and product). In a trigger group profile, each trigger group may be identified by an identification (ID) or name. In addition, each trigger may be identified by an ID or name (see the examples of FIG. 8 described below).

FIG. 8 illustrates exemplary trigger groups. The trigger group information of FIG. 8 may be stored as part of, for example, a look-up table or other data structure in memory and referenced by advanced planning manager 100 when reading a trigger group profile for a process block. In one embodiment, trigger group profiles may identify a trigger group by trigger group ID or name, which in turn serves as an index to identify the relevant trigger group information from a look-up table or other data structure. Alternatively, some or all of the trigger group information (such as that illustrated in FIG. 8) may be stored as part of the trigger group profile.

In FIG. 8, a first trigger group is shown that is identified by the name or ID as TriggerGroup1. TriggerGroup1 includes two triggers (MAN_TRIG=re-run planning manually triggered and MD=master data changed). As shown in the example of FIG. 8, TriggerGroup1 is assigned to two services (i.e., Forecast and Safety Stock). A second trigger group is also shown in FIG. 8. This trigger group is identified by the name or ID as TriggerGroup2. TriggerGroup2 includes two triggers (i.e., BADI=trigger value determined in BAdI (Business Add In) and New Product) and is assigned to one service (i.e., Forecast). TriggerGroup2 is also associated with the data object types Location Product and Product. As will be appreciated by those skilled in the art, the examples of FIG. 8 are provided for purposes of illustration and other combination of triggers and services may be provided.

As disclosed herein, each trigger group may contain one or more different triggers. A trigger group can be treated as a unit like a trigger and may be assigned to a service. In one embodiment, a trigger group may be deemed to be set (i.e., active) if at least one trigger of the trigger group is set.

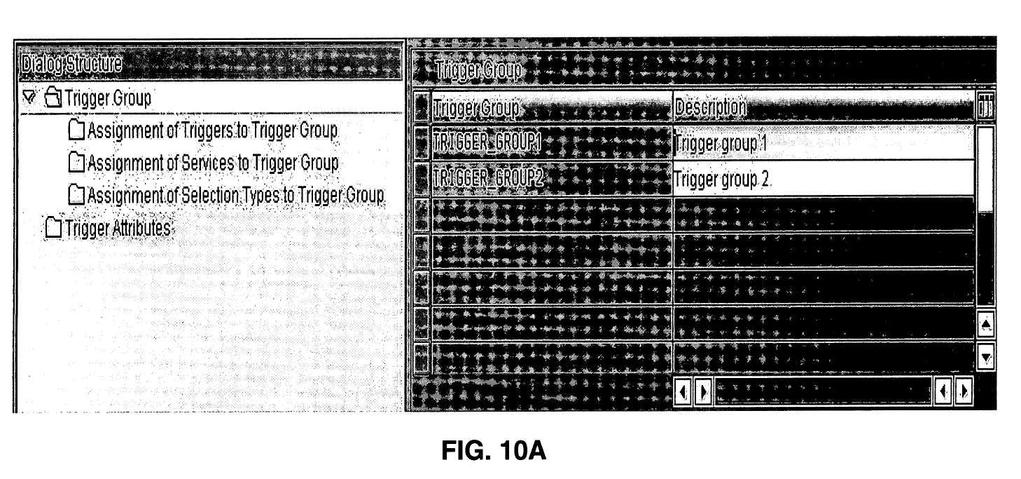

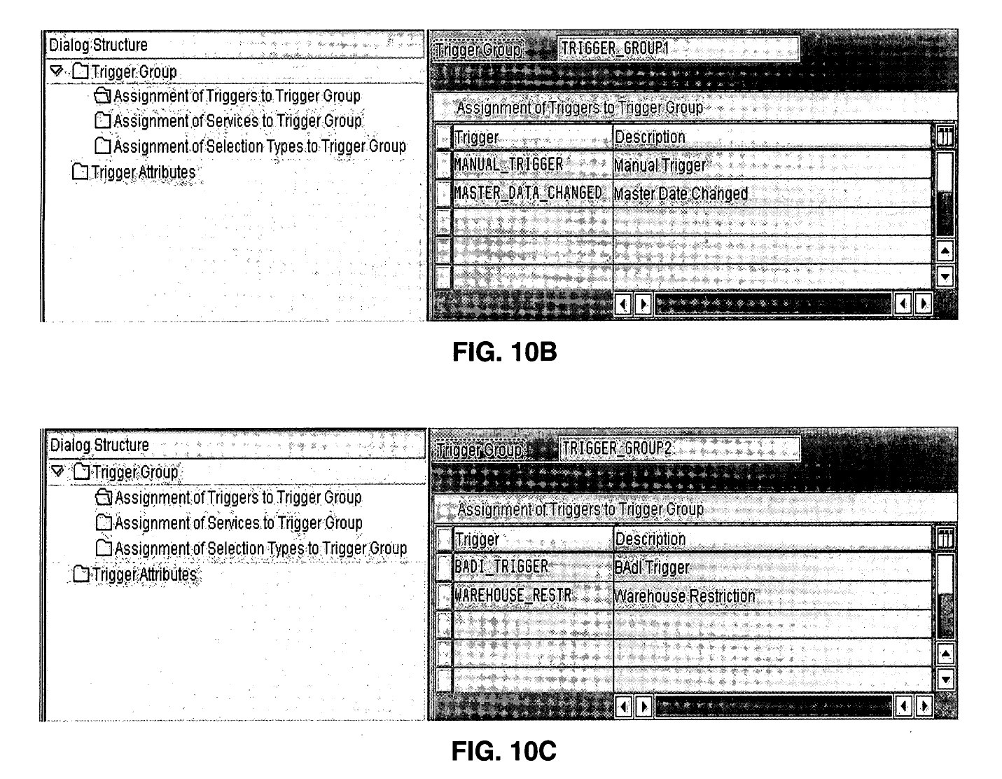

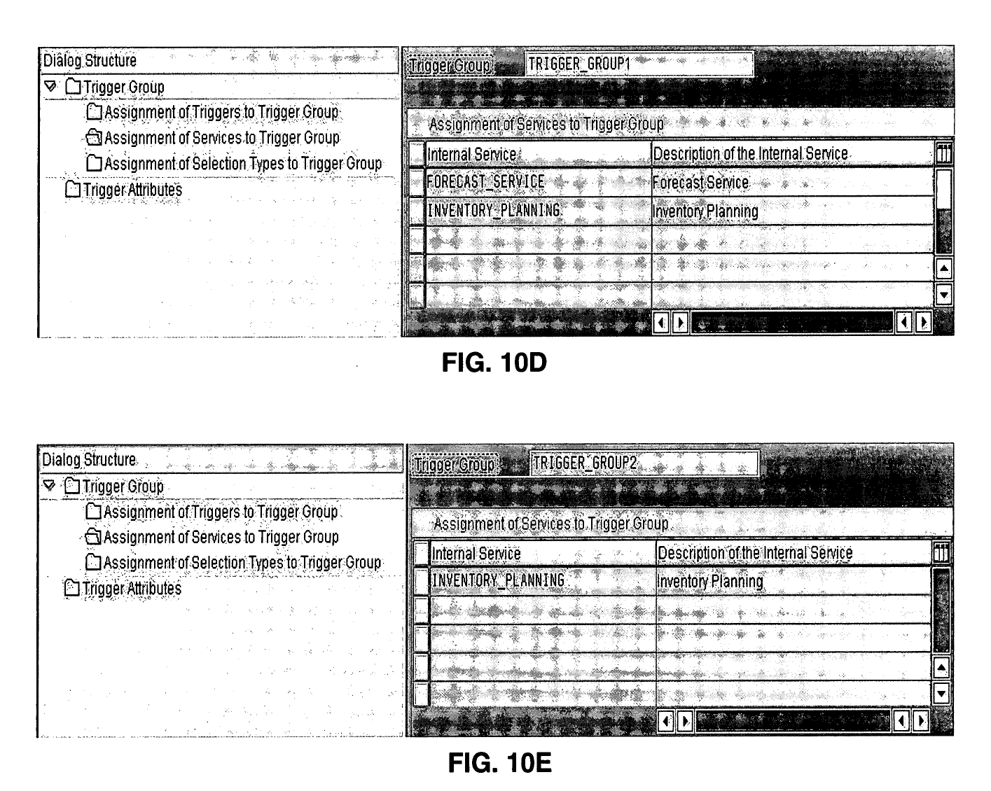

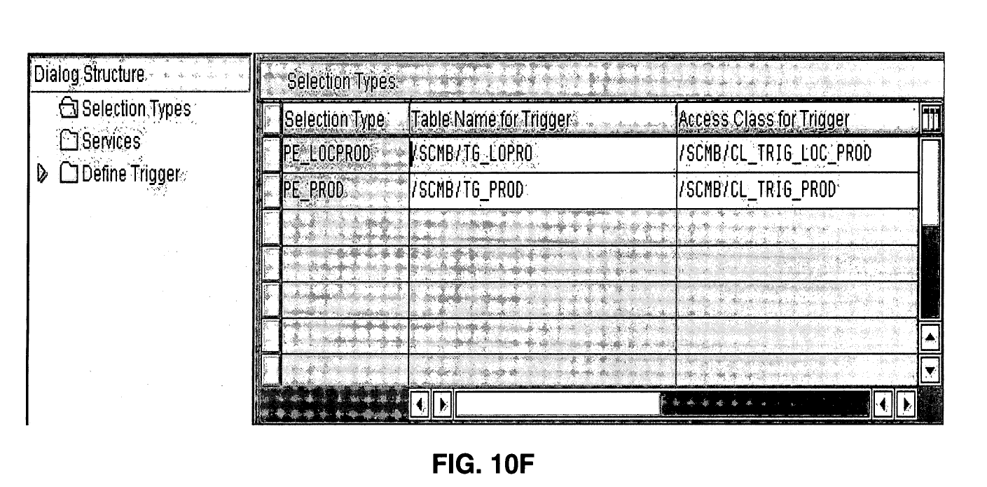

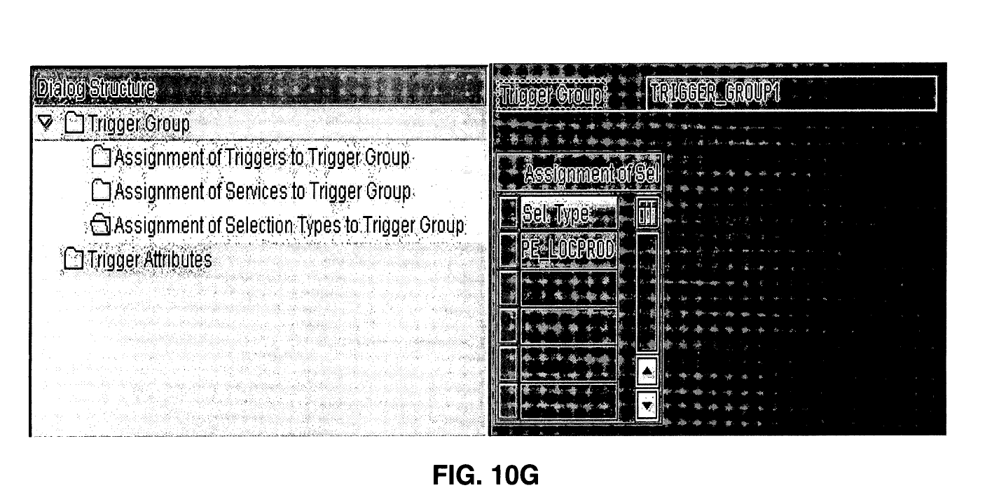

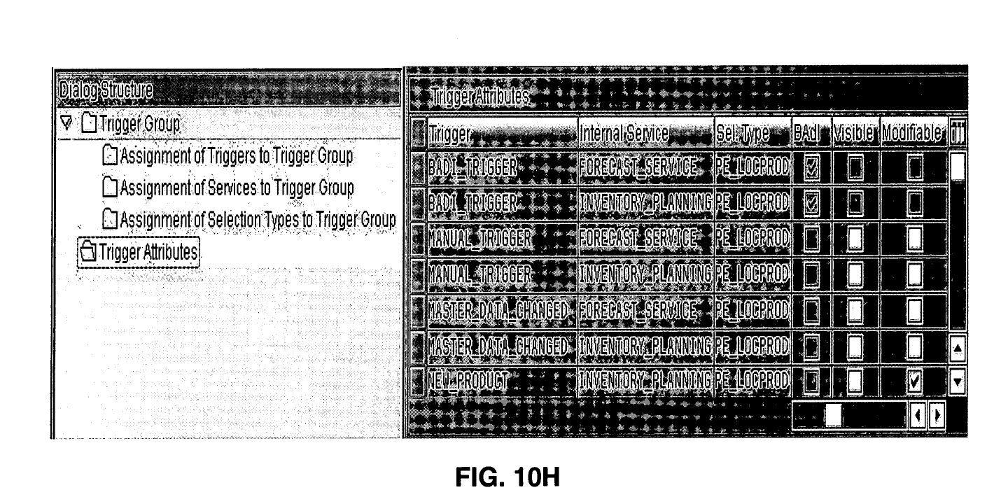

Consistent with embodiments of the invention, the creation and maintenance of triggers and/or trigger groups may be controlled by a user. In one embodiment, a library of triggers may be provided. In such a library, triggers may be predefined and assigned an ID or name. Using a GUI and/or other suitable application, the user may select triggers from the library to create and define a trigger group. The same or a similar GUI may also be used by a user to edit or update existing trigger groups (e.g., by adding or deleting trigger(s) assigned to a trigger group). When creating or editing a trigger group, a user may select or define the services to be assigned to the triggers in the group. Additionally or alternatively, one or more the triggers in the library may be pre-assigned to service(s). For purposes of illustration, exemplary interfaces for defining and managing trigger groups are discussed below with reference to FIGS. 10A to 10H.

Various methods may be provided for setting triggers. For example, in one embodiment, a library of triggers is provided that includes automated triggers. An automated trigger may be a trigger that is automatically set by the advanced planning manager 100, the services 130 or in any other application whenever a predefined activity is detected. By way of example, an automated trigger for manual inventory correction may be automatically set whenever a predefined activity (such as a recount to correct an inventory count) is detected. Other triggers may be manually setting triggers. A manual trigger may be a trigger that is manually set or made active by a user. For instance, a manual trigger for recalculation of Location Product may be manually set by a user when needed.

As disclosed herein, a trigger group profile for a process block may be user defined and include a trigger group ID or name to identify the trigger group and corresponding set of trigger(s) and services(s). Consistent with embodiments of the invention, trigger management functionality may be provided in advanced planning manager 100 to, for example, handle the application of triggers. To this end, the trigger management functionality of advanced planning manager 100 may work on a set of database tables for the defined trigger groups (see, for example, FIGS. 8 and 9) and monitor for activities to automatically set certain triggers based on the detection of relevant activities. Further, based on the status of the triggers for a process block, advanced planning manager may determine which objects require filtering versus those that require to be executed based on the listed services.

Referring now to FIG. 9, an exemplary database table will be described for providing trigger management functionality. Following from the examples of FIG. 8, FIG. 9 illustrates a table that includes information about the triggers and services associated with each trigger group (e.g., TriggerGroup1 and TriggerGroup2), as well as status information related to each of the triggers. FIG. 9 also illustrates the relationship between various selection types or objects (in this case location product) to which the services are assigned. The exemplary table of FIG. 9 may be stored in addition to or in place of the table of FIG. 8 and may be used by advanced planning manager 100 to provide trigger functionality, consistent with present the invention. As will be appreciated by those skilled in the art, other approaches may also be used such as storing the information of FIG. 9 in one or more tables or other data structures. For example, in one embodiment, the status (i.e., value for each trigger may be stored as part of a separate table or other data structure in memory).

Referring again to FIG. 9, the triggers (MAN_TRIG (Manual Trigger), MD (Master Data), New Product, BADI, etc.) may be assigned to one or more different services, such as Forecast and Safety Stock. Further, the triggers may be grouped into trigger groups and assigned to services. As shown in FIG. 9, TriggerGroup1 includes triggers MAN_TRIG and MD and TriggerGroup2 includes triggers New Product and BADI. Further, the services may be assigned to selection objects or types (e.g., Location Product). In the example of FIG. 9, the services associated with TriggerGroup1 are assigned to LOC_1-PROD_1, LOC_2-PROD_1, and LOC_3-PROD_1, whereas the services associated with TriggerGroup2 are assigned to LOC_1-PROD_2, LOC_2-PROD_2, and LOC_3-PROD_1. While not shown in FIG. 9, other combinations may exist (such as the combination LOC_3-PROD_2), but triggers may not be set for these combinations.

Triggers can be used to identify the planning objects to be executed. Further, triggers can be used to avoid inaccurate or inconsistent data (in whole or in part). If the results of one service are actualized, the trigger(s) can take care of actualizing the other depending planning results. Consider the following examples:

### EXAMPLE 1

The Safety Stock is calculated on the basis of Forecast results. If the Forecast is recalculated for the location product A, the trigger for the Safety Stock service and the location product A may be set so that the next planning run of the Safety Stock service will be executed for the location product A. This may require that the trigger is part of a trigger group that is selected in the planning profile of the advanced planning manager. The Safety Stock service may then set the trigger for Distribution Requirements Planning (DRP) in order to trigger the recalculation of DRP.

### EXAMPLE 2

A change of master data (e.g., the lead time) may invalidate the planning results for this master data (e.g., DRP). After changing the lead time in the master data, the trigger MD (Master Data) may be set using the trigger functionality. There may be other master data attributes for those the trigger MD or any other trigger may set. This may be any planning horizon, the assignment of the Bill of Distribution (BoD), or any indicator that defines how services do the calculation. The trigger may be set for all assigned services or for some services like, DRP, and the Safety Stock service. This may require that the trigger is part of a trigger group that is selected in the planning profile of the advanced planning manager 100.

Other features may be provided alone or in combination with the trigger functionality described above. For instance, the status of a trigger can be used by the advanced planning manager 100, the services 130 or in any other application to stimulate other functions (e.g., the purchasing of inventory).

For purposes of illustration, exemplary interfaces for enabling a user to define and manage trigger groups are shown in FIGS. 10A to 10H. The exemplary interfaces may be implemented as part of a GUI and displayed to a user by or under control of, for example, advanced planning service and data manager 100. As will appreciated by those skilled in the art, the examples of FIGS. 10A to 10H may be modified or adapted without departing from the scope of the invention. Further, other means may be provided to facilitate trigger group management.

As shown in FIG. 10A, an interface may be provided to provide a user with an overview of the trigger group(s). The exemplary interface of FIG. 10A includes control fields and buttons, as well as input fields, to permit a user to set-up and define each trigger group. For example, assume that the user wants to create two new trigger groups (Trigger Group 1 and Trigger Group 2). To do, the user may first enter a trigger group name or ID for each trigger group, as well as a brief description using the input fields provided in the interface (see FIG. 10A). Thereafter, the user may select the control fields from a hierarchical menu structure to assign triggers, services and object or selection types to each trigger group. Based on the user's selections, additional interfaces may be provided to permit the user to make or modify assignments.

FIGS. 10B and 10C illustrate exemplary interfaces for permitting a user to make trigger assignments to a trigger group. Triggers may be assigned by trigger name or ID. Further, as disclosed herein, triggers may be predefined and stored as part of a library and/or they may be customized or individually defined by a user. In the example of FIG. 10B, two triggers (Manual_Trigger and Master_Data_Changed) are assigned to Trigger Group 1. In contrast, in the example of FIG. 10C, two other triggers (BADITrigger and Warehouse_Restriction) are assigned to Trigger Group 2.

In addition to assigning triggers, a user may also assign services to a trigger group. For example, in the assignment interface of FIG. 10D, the user has assigned two services (Forecast_Service and Inventory_Planning) to Trigger Group 1. In the exemplary interface of FIG. 10E, only one service (Inventory_Planning) is assigned to Trigger Group 2. The same or similar interfaces may later be used by the user to make modifications or adjustments to the assignments for the trigger groups.

Consistent with the present invention, trigger groups may also be defined by a user through an object or selection type assignment. The exemplary interface of FIG. 10F shows the definition of an object or selection type (PE_LOCPROD for location product and PE_PROD for product) by, for example, table name and access class. Once defined, the object or selection type may be assigned to a trigger group. For instance, in the exemplary interface of FIG. 10G, the selection type, PE_LOCPROD, is assigned to Trigger Group 1.

Other interfaces may also be provided to facilitate trigger group management. For example, interfaces may be provided to enable a user to define triggers. Through such interfaces a user may be permitted to define the trigger (e.g., by name, description, attribute(s), etc.). Interfaces may also be provided to enable a user to manually activate or inactivate triggers, and/or modify existing triggers. In one embodiment, only triggers that are defined with an attribute that indicates that they are visible may be selectively activated/inactivated by a user, and only triggers that are defined with an attribute indicating they are modifiable may be modified by a user.

As a further example of an interface for trigger management, FIG. 10H illustrates an exemplary interface for defining trigger attributes. As shown in FIG. 10H, triggers associated with services may be displayed to a user to aide in setting the attributes for the triggers. As disclosed above, attributes such as whether a trigger is visible to a user or modifiable by a user may be set through the interface.

Consistent with embodiments of the invention, advanced planning manager 100 may provide data management during the execution of services. Data management may include the control of access and storage of data to and from database 120. For companies, organizations and other users, database 120 may be adapted to store large quantities of data of various types (e.g., master data, transactional data, etc.). To facilitate data management for such arrangements, advanced planning manager 100 may buffer and/or control the buffering of data from database 120 during the execution of services. Consistent with embodiments of the invention, this may be achieved by using one or more data managers.

In one embodiment, each object may have its own data manager. Further, an interface may be provided for each data manager to permit the planning services to read and write data from database 120. In addition, during the execution of the process blocks, each data manager may provide buffering and save new or modified data to database 120. Such data management can reduce the frequency or number of database accesses and, thus, improve processing time.

With reference to the embodiment of FIG. 2, interfaces 114A-114N may be provided to facilitate communication between the various services and data managers. Such interfaces may be object orienting programming (OOP) implementations and may be provided for each data type or kind. For example, data manager interfaces may be created for time series data, master data, transactional data, etc. stored in database 120. It is also possible to create interfaces for different levels of data (e.g., interfaces may be created for the different levels of data within master data, such as part data, location data, etc.). Moreover, the data manager interfaces may be created with restrictions (e.g., a data access restriction such as “read only”).

Consistent with embodiments of the invention, each data manager may implement an interface for one or more specific services provided by the advanced planning manager 100. By way of example, a service such as a storage service may be provided for saving data to the database and for freeing all buffers. With a storage service interface, a data manager may be called by the storage service to save data or free buffers.

Various types of data buffering may be provided. For example, buffering may be handled on a “normal” or “special” basis. During normal processing, a buffer may be created by a data manager per process block or per package within a process block. At the end of executing the list of services for each process block or package, any changed data may be saved and all buffers released or cleared. On a special basis, the storage service may be called at a step within the execution of a list of services (e.g., service 1, service 2, service 3, storage service, service 5, service 6). The placement of the storage service within the list of services may be user defined, along with the order of the other services. When the storage service is reached during execution, any new or changed data may be stored and the relevant buffers may be cleared. In accordance with one embodiment, the execution of the storage service on a “special” basis may be applied for all or only specific data managers.

To provide a further understanding of the scope of the invention, FIG. 11 is an exemplary class diagram for implementing a data manager through, for example, OOP techniques. As shown in FIG. 11, the class diagram includes a number of components or objects, including a data manager 1100 which implements a data manager interface 1110 and a storage service interface 1115. Each data manager object has one or more data objects (=buffer) 1120. The data objects may be created when the data manager access database 120.

For a service to access the data manager, the service may call a data directory look-up method. As will be appreciated by those skilled in the art, such a data directory may be implemented using conventional methods, such as the factory method or other known techniques. In general, the data directory may provide a list of all available data managers and provide access to the data managers. When a service calls the data directory, it may include the name of the relevant data manager. In response, the service may receive an object reference for the requested data manager (or, more precisely, the data manager interface). With the object reference, the service can access all data manager methods.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for managing data for the execution of a plurality of planning services, the planning services using one or more objects represented by data stored in a database, the method comprising:
reading a planning profile with at least one process block, the at least one process block including a list of planning services to be executed, and a selection profile, the selection profile including selection criteria for specifying which of the objects stored in the database are required for processing the at least one process block;
providing a data manager for each object to be processed in connection with the at least one process block; and
executing each planning service in accordance with the list of planning services and the objects specified by the selection criteria, whereby each data manager controls the access of data to and from the database during the execution of the planning services.

2. A method according to claim 1, wherein each data manager is adapted to buffer data during execution of the planning services.

3. A method according to claim 1, wherein the method further comprises executing a storage service, the execution of the storage service causing buffered data to be released and saved to the database.

4. A method according to claim 3, wherein only new or modified data is saved to the database by each data manager.

5. A method according to claim 1, wherein providing a data manager for each object comprises implementing an interface for each data manager to facilitate communication between the planning services and data managers.

6. A method according to claim 5, wherein implementing an interface for each data manager comprises implementing a storage service interface for a storage service, and wherein the method further comprises using the storage service interface to call each data manager, and to save data or free buffered data.

7. A method according to claim 1, wherein the at least one process block further comprises a process profile, the process profile including criteria for defining a process for building packages of objects to execute the list of planning services.

8. A method according to claim 7, wherein the process for building the packages is at least one of: building packages of the same package size n, and building a given number n of packages.

9. A method according to claim 7, wherein the process for building the packages includes at least one of: building packages of a minimum package size, and building packages of a maximum package size.

10. A method according to claim 7, wherein the process profile of the at least one process block further includes criteria for defining how to process the packages when executing the list of planning services.

11. A method according to claim 10, wherein the criteria for defining how to process the packages indicates at least one of parallel processing and sequential processing.

12. A method according to claim 1, wherein the list of planning services are executed for at least one of enterprise resource planning (EPR), supply chain management (SCM), customer relationship management (CRM), warehouse management (WM), and product lifecycle management (PLM).

13. A system for managing data, the system comprising:
a database for storing one or more objects, each of the objects being represented by data stored in a database;
a plurality of planning services, each of the planning services being implemented with software and providing predetermined functionality;
an advanced planning manager for executing the plurality of services and managing the data stored in the database, the advanced planning manager comprising programmable instructions for causing a processor to perform the following steps:
reading a planning profile with at least one process block, the at least one process block including a list of planning services to be executed, and a selection profile, the selection profile including selection criteria for specifying which of the objects stored in the database are required for processing the at least one process block;
providing a data manager for each object to be processed in connection with the at least one process block; and
executing each planning service in accordance with the list of planning services and the objects specified by the selection criteria, whereby each data manager controls the access of data to and from the database during the execution of the planning services.

14. A system according to claim 13, wherein the predetermined functionality of the planning services is related to at least one of enterprise resource planning (EPR), supply chain management (SCM), customer relationship management (CRM), warehouse management (WM), and product lifecycle management (PLM).

15. A system according to claim 13, wherein the planning profile comprises a plurality of process blocks, and wherein the advanced planning manager further comprises instructions for processing each of the process blocks according to the order in which they are provided in the planning profile.

16. A system according to claim 13, wherein each data manager is adapted to buffer data during execution of the planning services.

17. A system according to claim 13, wherein the advance planning manager further comprises instructions for executing a storage service, the execution of the storage service causing buffered data to be released and saved to the database.

18. A system according to claim 17, wherein only new or modified data is saved to the database by each data manager.

19. A system according to claim 13, wherein providing a data manager for each object comprises implementing an interface for each data manager to facilitate communication between the planning services and data managers.

20. A system according to claim 19, wherein implementing an interface for each data manager comprises implementing a storage service interface for a storage service, and wherein the advance planning manager further comprises instructions for using the storage service interface to call each data manager, and to save data or free buffered data.

21. A system according to claim 13, wherein the advanced planning manager further comprises instructions for building packages of objects for processing.

22. A system according to claim 21, wherein the at least one process block further comprises a process profile, the process profile including criteria for defining a process for building the packages.

23. A system according to claim 22, wherein the process for building the packages is at least one of: building packages of the same package size n, and building a given number n of packages.

24. A system according to claim 22, wherein the process for building the packages includes at least one of: building packages of a minimum package size, and building packages of a maximum package size.

25. A system according to claim 22, wherein the process profile of the at least one process block further includes criteria for defining how to process the packages when executing the plurality of planning services.

26. A system according to claim 25, wherein the criteria for defining how to process the packages indicates at least one of parallel processing and sequential processing.

27. A system for managing data for the execution of a plurality of services using one or more objects stored in a database, the system comprising:
means for reading a planning profile with at least one process block, the at least one process block including a list of services to be executed, and a selection profile, the selection profile including selection criteria for specifying which of the objects stored in the database are required for processing the at least one process block;
means for providing a data manager for each object to be processed in connection with the at least one process block; and
means for executing each planning service in accordance with the list of services and the objects specified by the selection criteria, whereby each data manager controls the access of data during the execution of the services.

28. A system according to claim 27, wherein each data manager is adapted to buffer data during execution of the services.

29. A system according to claim 27, wherein the system further comprises means for executing a storage service, the execution of the storage service causing buffered data to be released and saved to the database.

30. A system according to claim 29, wherein only new or modified data is saved to the database by each data manager.

31. A system according to claim 27, wherein the means for providing a data manager for each object comprises means for implementing an interface for each data manager to facilitate communication between the services and data managers.

32. A system according to claim 31, wherein the means for implementing an interface for each data manager comprises means for implementing a storage service interface for a storage service, and wherein the system further comprises means for using the storage service interface to call each data manager, and to save data or free buffered data.

33. A computer program product comprising a computer readable medium with instructions for causing a processor to perform a method for managing data, the method comprising:
reading a planning profile with at least one process block, the at least one process block including a list of services to be executed, and a selection profile, the selection profile including selection criteria for specifying which of objects stored in a database are required for processing the at least one process block;
providing a data manager for each object to be processed in connection with the at least one process block; and
executing each service in accordance with the list of services and the objects specified by the selection criteria, whereby each data manager controls the access to data during the execution of the services.

34. A computer program product according to claim 33, wherein each data manager is adapted to buffer data during execution of the services.

35. A computer program product according to claim 33, wherein the method further comprises executing a storage service, the execution of the storage service causing buffered data to be released and saved to the database.

36. A computer program product according to claim 35, wherein only new or modified data is saved to the database by each data manager.

37. A computer program product according to claim 33, wherein providing a data manager for each object comprises implementing an interface for each data manager to facilitate communication between the services and data managers.

38. A computer program product according to claim 37, wherein implementing an interface for each data manager comprises implementing a storage service interface for a storage service, and wherein the system further comprises means for using the storage service interface to call each data manager, and to save data or free buffered data.
